(19) United States
(12) Patent Application Publication
(10) Pub. No.: US 2022/0258799 A1
(43) Pub. Date: Aug. 18, 2022

(54) STEERABLE COUPLING LINKAGE FOR AN ARTICULATED VEHICLE

(71) Applicants: Yvon Martel, Chicoutimi (CA); Michael Martel, Chicoutimi (CA)

(72) Inventors: Yvon Martel, Chicoutimi (CA); Michael Martel, Chicoutimi (CA)

(21) Appl. No.: 17/597,661

(22) PCT Filed: Jul. 16, 2020
(86) PCT No.: PCT/CA2020/050987

§ 371 Date: Jan. 17, 2022

Related U.S. Application Data
(60) Provisional application No. 62/874,831, filed on Jul. 16, 2019.

(51) Int. Cl. B62D 12/00; B60D 1/24; B60D 1/06

(52) U.S. Cl. CPC B62D 12/00; B60D 1/06; B60D 1/246

(57) ABSTRACT

The steerable coupling linkage (106) is provided between a primary unit (100) and a secondary unit (102) arranged in tandem to form an articulated vehicle (104). The steerable coupling linkage (106) includes a steering actuator mechanism (200) having a transversally disposed actuator (202). The steerable coupling linkage (106) is particularly well adapted when the articulated vehicle (104) must travel on difficult and rugged terrains. It is very compact and lightweight, and the units (100, 102) can be attached or detached very quickly even when they are not in alignment with one another.

### CROSS REFERENCE TO PRIOR APPLICATION

The present case claims the benefits of U.S. patent application No. 62/874,831 filed 16 Jul. 2019. The entire contents of this prior patent application are hereby incorporated by reference.

### TECHNICAL FIELD

The technical field generally relates to steerable coupling linkages set between parts of vehicular units arranged in tandem to form articulated vehicles, for instance articulated vehicles capable of travelling over difficult terrains, such as terrains covered with snow, sand, mud, etc.

### TECHNICAL BACKGROUND

Various small vehicles have been suggested over the years for travelling on difficult terrains. Some are referred to as compact pulling apparatuses, such as those disclosed in U.S. Pat. Nos. 8,453,769, 9,694,859 and 9,821,865. Apparatuses of this sort are very useful as light means of transportation, particularly where it is difficult or even forbidden to travel using a larger or heavier vehicle. For example, on snow-covered surfaces, the snow could be too powdery or too deep for a snowmobile but not for such compact apparatuses. Another among the numerous advantages of these compact apparatuses is that they are much easier to transport in other vehicles compared for instance to snowmobiles or the like.

WO 2019/104436 A1 published 6 Jun. 2019 discloses a steerable coupling linkage for use between a compact pulling apparatus and a hauled unit to form an articulated vehicle. The steerable coupling linkage includes a drawbar clamping assembly affixed on the top outer surface of a rigid protective casing to removably secure a drawbar at the front of the hauled unit. The drawbar includes a trailer hitch, located at the front end, that can be set over a towing ball projecting upwards on the casing. The steerable coupling linkage also includes a steering actuator located inside the casing to selectively control the relative angular position of the casing with reference to the apparatus about the yaw axis, thereby allowing the articulated vehicle to be steered with a remarkable agility even on very rugged terrains. However, this system was found to be relatively heavy and cumbersome in the context of some implementations, and when the hauled unit is detached from the apparatus, the casing still extends beyond the rear end of the apparatus, thereby increasing its overall length and the required space for its storage or transportation. The system also involved having a relatively long drawbar at the front of the hauled unit and the drawbar clamping assembly was found to be difficult to close under some conditions, for instance if the apparatus and the hauled unit at not perfectly in alignment with one another when this needs to be done.

Additional improvements on many different aspects of steerable coupling linkages for articulated vehicles are always desirable so as to advance the technology in this technical area even further.

### SUMMARY

The proposed concept involves, among other things, a steerable coupling linkage that can attach two complementary units juxtaposed in tandem to form an articulated vehicle where the required space for transporting or storing the primary unit is not increased or is not significantly increased by the parts when the two units are unattached.

There is also provided a steerable coupling linkage that can be constructed without a rigid protective casing to support the steering actuator and to attach a drawbar, thereby reducing weight and costs.

There is also provided a steerable coupling linkage where the primary unit and the secondary unit can be positioned closer to one another.

There is also provided a steerable coupling linkage where the primary unit and the secondary unit can be attached or detached relatively easily and quickly even when they are not perfectly in alignment with one another.

There is also provided a steerable coupling linkage that can provide, if desired, a pitch axis and a roll axis in addition to a yaw axis, and where at least one among the pitch axis and the roll axis can be limited in range or even blocked.

There is also provided a steerable coupling linkage that can attach two units even if none of them have a drawbar or a similar arrangement.

According to one aspect, there is provided a steerable coupling linkage as defined in the claim 1.

According to another aspect, there is provided a steerable coupling linkage as shown and/or described and/or suggested herein.

According to another aspect, there is provided an articulated vehicle as shown and/or described and/or suggested herein.

According to another aspect, there is provided a method of coupling two units in tandem to form an articulated vehicle, as shown and/or described and/or suggested herein.

Further details on the various aspects as well as other aspects and features of the proposed concept will become apparent in light of the detailed description which follows and the appended figures.

### BRIEF DESCRIPTION OF THE FIGURES

FIG. 1 is an isometric top view of an example of an articulated vehicle formed by two units arranged in tandem that are mechanically connected to one another by an example of a steerable coupling linkage as proposed herein;

FIG. 2 is a side view of the articulated vehicle in FIG. 1;

FIG. 3 is a front isometric top view of the steerable coupling linkage in FIG. 1;

FIG. 4 is a rear isometric top view of the steerable coupling linkage in FIG. 1;

FIG. 5 is a view similar to FIG. 3 but where the subparts of the middle section are detached;

FIG. 6 is a front isometric and partially exploded top view illustrating only the front section and the bottom subpart of the middle section shown in FIG. 3;

FIG. 7 is an enlarged front isometric top view of some of the parts shown in FIG. 6;

FIG. 8 is a rear isometric bottom view of the parts shown in FIG. 7;

FIG. 9 is a front isometric and partially exploded top view illustrating only the top subpart of the middle section and the rear section shown in FIG. 3;

FIG. 10 is a rear isometric and partially exploded bottom view of the parts shown in FIG. 9;

FIGS. 11 and 12 are longitudinal cross-section views illustrating the operation of the roll locking arrangement in the steerable coupling linkage shown in FIG. 3;

FIG. 13 is a transversal cross-section view made across the rear section and illustrating the operation of the roll damper mechanism in the steerable coupling linkage shown in FIG. 3;

FIGS. 14 and 15 are views similar to FIGS. 7 and 8, respectively, but illustrating variants thereof;

FIG. 16 is a view similar to FIG. 10 but illustrating variants thereof;

FIGS. 17 and 18 are transversal cross-section views illustrating the operation of the roll locking arrangement in the steerable coupling linkage shown in FIG. 16;

FIG. 19 is an isometric top view of another example of a steerable coupling linkage as proposed herein;

FIG. 20 is a front isometric top view of a portion of the steerable coupling linkage shown in FIG. 19; and

FIG. 21 is a rear isometric and partially exploded bottom view of the parts shown in FIG. 20.

### DETAILED DESCRIPTION

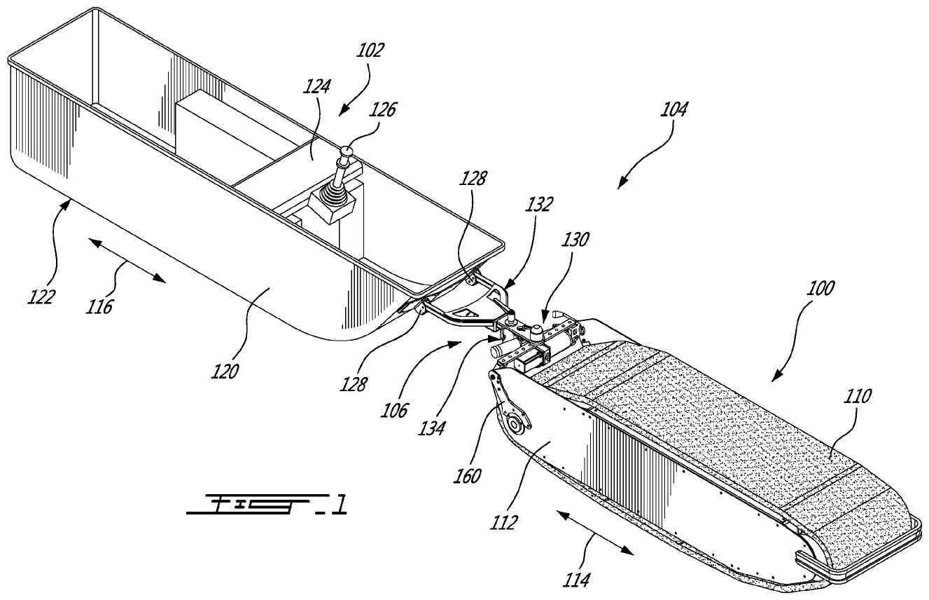

FIG. 1 is an isometric top view of an example of an articulated vehicle 104 formed by two units 100, 102 arranged in tandem, namely two units that are immediately adjacent to one another, that are mechanically connected to one another by an example of a steerable coupling linkage 106 as proposed herein. One will be referred to as a primary unit 100 and the other as a secondary unit 102. While some exceptions exist, the primary unit 100 will be considered to be the front or leading device and the secondary unit 102 is thus the rear or trailing device. In this implementation, the primary unit 100 is a compact pulling apparatus and the secondary unit 102 is a hauled device, both being directly and removably attached together to form the illustrated articulated vehicle 104. The primary unit 100 and the secondary unit 102 are themselves vehicles in a broad sense, the primary unit 100 being an automotive vehicle providing the motive power to drive the whole vehicle 104 and the secondary unit 102 being a nonautomotive vehicle in this implementation. The terms primary unit and secondary unit are essentially used to designate the apparatuses or devices that are connected to one another by the steerable coupling linkage 106.

The present detailed description often refers to the primary unit 100 as being an automotive apparatus located at the front and the secondary unit 102 as a nonautomotive device located at the rear, the front/rear position referring to the normal forward travel direction of the articulated vehicle 104. This is only for the sake of simplicity since many other configurations and arrangements are possible. For instance, the primary unit 100 can be configured to push the secondary unit 102 when travelling in the forward direction. The primary unit 100 is thus not necessarily always to the front of the articulated vehicle 104. The articulated vehicle 104 could include more than two units. The secondary unit 102 could be an automotive apparatus or device in some implementations. Other variants are possible as well.

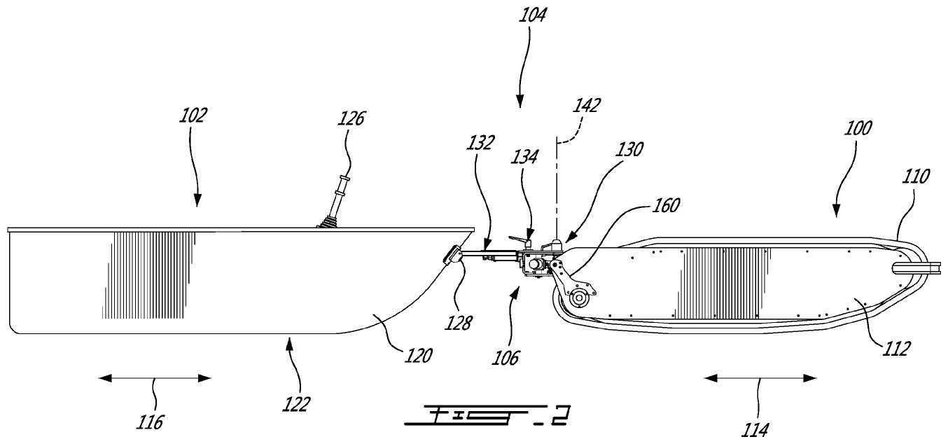

FIG. 2 is a side view of the articulated vehicle 104 in FIG. 1.

The primary unit 100 can be a compact pulling apparatus, as shown in FIG. 1. This apparatus can be for instance one of the apparatuses disclosed in applicant's previous patents and patent applications, such as in U.S. Pat. Ser. Nos. 8,453,769, 9,694,859 and 9,821,865, to name just a few. The entire contents of these documents are incorporated herein by reference in their entirety. The primary unit 100 can be constructed differently if desired. The primary unit 100 includes an endless track 110 disposed around a housing 112 having an elongated form. The rotation of the track 110 around the housing 112 enables this apparatus to move over a ground surface in a forward or rearward direction. It can be used on almost any ground surfaces, including snow, ice, paved roads, mud, sand, etc. The track 110 can be made of rubber or other flexible materials. Other configurations and arrangements are possible. For instance, the track 110 can include a multitude of small interconnected parts that are not made of a flexible material. Other variants are possible as well.

The housing 112 of the primary unit 100 can have a low-slung configuration in order to keep its centre of gravity as low as possible, as shown. The housing 112 can also be made watertight. Other configurations and arrangements are possible. For instance, at least some parts of the housing 112 may not necessarily be or always be watertight in some implementations. It should be noted at this point that any reference to a “watertight” housing generally means that the interior of most of the housing 112 will remain dry in during normal use even if it is operated or otherwise subjected to a very wet and damp environment, among other things. Having a watertight housing 112 allows the articulated vehicle 104 to cross a stream or another small body of water, and it can even be made so as to float in some implementations. The term watertight does not exclude the presence of openings for an air ventilation circuit drawing outside air into the housing 112 and expelling air therefrom. A ventilation circuit can be provided for instance to cool the interior of the housing 112 when its temperature exceeds an upper threshold, such as above 25° C. Other values are possible. Hence, the interior of the housing 112 is not necessarily entirely sealed off from the outside to be considered watertight. Other variants are possible as well.

The housing 112 of the illustrated primary unit 100 generally extends along a corresponding longitudinal axis 114. The illustrated secondary unit 102 also generally extends along a corresponding longitudinal axis 116. The illustrated articulated vehicle 104 will travel in a straight line on a flat and levelled horizontal ground surface when these two longitudinal axes 114, 116 are oriented parallel to one another, thus when the two units 100, 102 of the illustrated example are in a longitudinal alignment, as shown in FIG. 1.

The illustrated primary unit 100 includes at least one track-driving motor for generating rotating output power to move the track 110. The motor or motors can be located within the housing 112 and can be, for instance, an electric motor using electrical energy coming from batteries and/or from another source, a fuel-powered internal combustion engine (ICE), or both. When an electric motor and an ICE are both present, the electric motor can be an electric machine having both a power generator mode where it is capable of generating electrical energy using rotating output power coming from the ICE, and an electric motor mode where it is capable of generating rotating output power using electrical energy coming from the batteries and/or from another source. Nevertheless, one can use an electric machine that is only an electric motor (i.e., no power generator mode driven by an ICE) in some implementations or, in others, an electric machine that is only a power generator (i.e., no electric motor mode). A primary unit 100 such as the one shown in FIG. 1 can further include only an electric motor and no ICE (i.e., be exclusively electric) or only an ICE (i.e., no electric machine therein, except a possible electric starter). Other configurations and arrangements are possible. For instance, the location and/or the kinds of motors or engines and/or the nature of the energy source can be different. Other variants are possible as well.

If desired, an external rack or platform can be installed over the housing 112 of the primary unit 100, for instance at a minimal short distance above the track 110, to receive a payload, additional batteries, equipment, etc. In some implementations, one or more storage spaces can be provided inside the housing 112 of the primary unit 100. These storage space or spaces could be accessed, for instance, by removing side panels or through access doors (not shown). Other arrangements and configurations also possible. For instance, external racks and/or internal storage spaces can be omitted in some implementations. Other variants are possible as well.

The secondary unit 102 in the articulated vehicle 104 shown in FIGS. 1 and 2 is a sled. The illustrated sled is only a generic example for the sake of explanation. It includes an elongated main body or hull 120 opened at the top and that can provide space for transporting one or more persons and/or a payload. The main body 120 has a closed bottom side 122 and in this implementation, the surface of the bottom side 122 directly engages the ground surface in normal use. This sled is mostly designed for use on snow and ice but, nevertheless, it can be used on other kinds of ground surfaces, at least over short distances. Other configurations and arrangements are also possible. For instance, the secondary unit 102 can include ground-engaging skis or be in the form of a trailer with one or more wheels. The secondary unit 102 could also be a closed structure for accommodating one or more persons and/or a payload or, alternatively, be used for other purposes without being able to receive any person or cargo. The secondary unit 102 can even be significantly larger in width, height and/or length than that of the primary unit 100 in some implementations. It can also be significantly smaller in others. Still, one can provide one or more supplementary devices to the basic articulated vehicle 104 formed by the primary and secondary units 100, 102. These supplementary devices are called hereafter additional units. For instance, one additional unit can be attached behind the secondary unit 102 using a conventional trailer drawbar arrangement or any other kind, including another steerable coupling linkage as proposed herein. In some implementations, the secondary unit 102 could be another compact apparatus that is similar or identical to the primary unit 100, and one or more of the additional units, if any, could also be a compact apparatus. Having two compact apparatuses that are attached in tandem through an intervening steerable coupling linkage as proposed herein could be useful in some circumstances, such as when an increased towing capacity is needed. Other variants are possible as well.

The main body 120 of the secondary unit 102 illustrated in FIGS. 1 and 2 includes a transversally extending seat 124 where an operator and/or one or more passengers can sit. It also includes a joystick controller 126 to be handled by the operator for controlling the steering direction (right or left) and other parameters of the articulated vehicle 104, such as the travel speed, the braking force to be applied, the travel direction (forward or reverse), etc. It can also include a master switch, buttons for electric equipment such as headlights, and many others. The joystick controller 126 can communicate with the primary unit 100 using a wired communication link, a wireless communication link, or both. A wireless communication link is used in the illustrated example and the joystick controller 126 sends electronic signals to an electronic module or the like located on the primary unit 100, for instance inside the housing 112. The wireless link can be established via a radio channel, an infrared channel, or any other suitable method. Other configurations, arrangements and methods are possible. For instance, the joystick controller 126 can be connected by wire to an electronic module or the like that is inside the secondary unit 102 and that communicates with the primary unit 100. The operator does not necessarily need to be located on the secondary unit 102 to control the articulated vehicle 104. The joystick controller 126 can be made removable from the secondary unit 102 and can be carried by the operator standing next to the articulated vehicle 104. Accordingly, the secondary unit 102 may not necessarily have a seat or even room for a person. In some implementations, the operator could even be located at a remote location, using for instance cameras or other technical features, and/or the control of the articulated vehicle 104 can be partially or fully automated during a portion or even during the entire operation of the articulated vehicle 104. The operator could thus be a computer in some implementations. A human operator can control the articulated vehicle 104 through another kind of interface or arrangement that is not or does not include a joystick or the like. Other variants are possible as well.

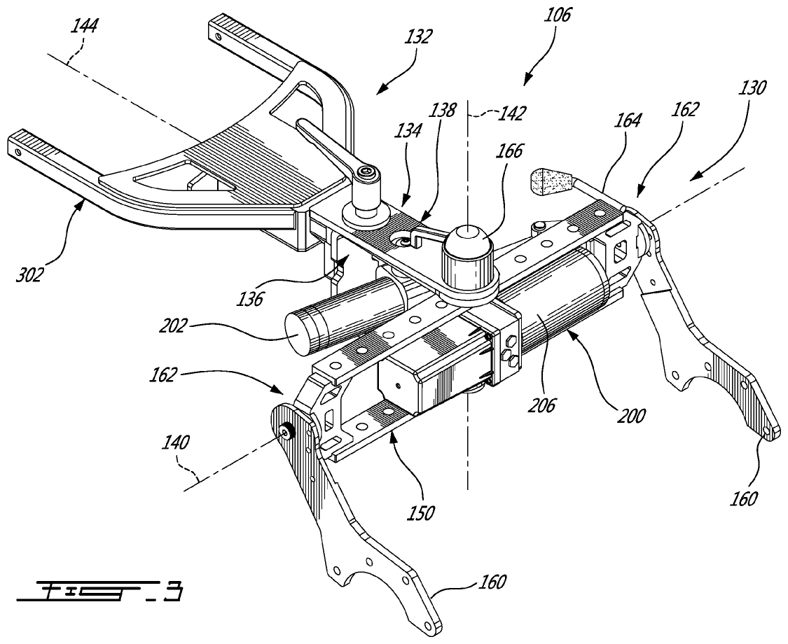

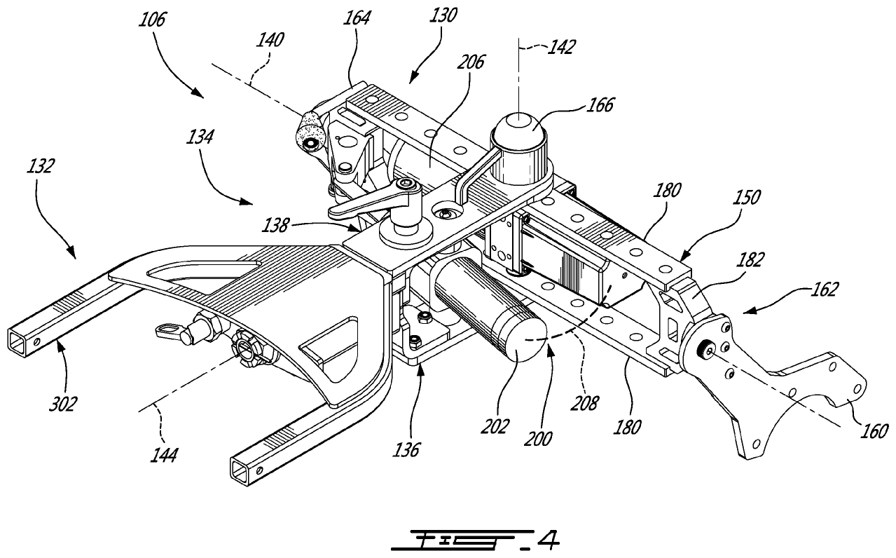

FIG. 3 is a front isometric top view of the steerable coupling linkage 106 in FIG. 1. FIG. 4 is a rear isometric top view thereof.

The steerable coupling linkage 106 can include a front section 130 and a rear section 132 that are attached by a middle section 134, as shown. The middle section 134 can also include two detachable subparts 136, 138, as shown. Such arrangement allows the front and rear sections 130, 132 to be completely detached from one another, for instance by the operator of the articulated vehicle 104. Although the two subparts 136, 138 are essentially superimposed when the illustrated steerable coupling linkage 106 are fully assembled, one of them will remain attached to the front section 130 and the other with the rear section 132 when they are disconnected. They are thus referred to as the main bottom subpart 136 and the top subpart 138 for the sake of simplicity. Separating the units 100, 102 of the articulated vehicle 104 will facilitate storage and transportation, among other things. This can also allow the interchangeability of the units 100, 102, thus possibility of using the primary unit 100 with a different secondary unit 102, or vice versa. The subparts 136, 138 of the middle section 134, as well as the corresponding front and rear sections 130, 132 attached to them, can originate from two distinct steerable coupling linkages 106 but they can still be considered to be part of the same steerable coupling linkage 106 once the two units 100, 102 are attached. Other configurations and arrangements are also possible. For instance, the steerable coupling linkage 106 can be designed so that the subparts 136, 138 are not easily removable from one another in normal use, or even not at all. Accordingly, some implementations may not necessarily have a middle section 134 as shown and described herein. Other arrangements can be made to allow the front and rear sections 130, 132 to be detached from one another. In some implementations, the rear section 132 could be at least partially integrated to the secondary unit 102. In its simplest basic form, the steerable coupling linkage 106 may possibly include only the front section 130. Other variants are possible as well.

The rear section 132 can have a substantially U-shaped configuration and it can be pivotally attached at the front of the main body 120, as shown, thereby allowing the secondary unit 102 and the rear section 132 to pivot with reference to one another around a substantially horizontal transversal pivot axis. The pivot attachment can be made using two spaced-apart coaxial hinges 128. The rear section 132 can also be made detachable from the hinges 128 by using removable pins or the like. The secondary unit 102 and the rear section 132 of the steerable coupling linkage 106 will remain in longitudinal alignment with the longitudinal axis 116 of the secondary unit 102 during the operations of the articulated vehicle 104. Other configurations and arrangements are possible. The rear section 132 can be constructed differently and/or the hinges 128 can be constructed differently or even be omitted. Other kinds of attachments, including a rigid attachment and/or using a single point of attachment between the secondary unit 102 and the rear section 132, are also possible. Other variants are possible as well.

The steerable coupling linkage 106 can create three distinct and independent main pivot axes around which the primary unit 100 and the secondary unit 102 are articulated, as shown. The main pivot axes are a pitch axis 140, a yaw axis 142, and a roll axis 144. These axes 140, 142, 144 are substantially orthogonal to one another in the illustrated example. The yaw axis 142 is schematically illustrated in FIG. 2. The pitch axis 140 and the roll axis 144 are schematically illustrated in FIGS. 3 and 4. These axes 140, 142, 144 can also be seen in other figures. Corresponding mounts are provided to pivotally join the different components. The pitch axis 140 can be a substantially horizontal and transversal axis around which the primary unit 100 and the secondary unit 102 can pivot relative to one another, as shown. It allows the units 100, 102 to have a different slope angle, for instance to compensate for a sudden variation of the surface inclination when an obstacle is encountered or at the transition between a steep hill and a flat surface located at the top or bottom thereof, to name just a few. The front section 130 pivots around the pitch axis 140, along with the rear and middle sections 132, 134. The yaw axis 142 can be a substantially vertical axis that is located at the widthwise geometric centre of the primary unit 100, as shown. It is located closer to the rear of the primary unit 100 than to the front of the secondary unit 102 in the illustrated example. The roll axis 144 can be a substantially horizontal axis that is parallel to the longitudinal axis 116 of the secondary unit 102 when the units 100, 102 are in registry on a levelled horizontal ground surface, as shown. The roll axis 144 allows the primary unit 100 and the secondary unit 102 can be “twisted” with reference to one another to more easily conform to the changing contours of the terrain over which the articulated vehicle 104 passes, often maintaining the track 110 in an optimum tractive engagement with the ground surface and improving the manoeuvrability on some rugged terrains, among other things. Other configurations and arrangements are possible. For instance, the steerable coupling linkage 106 can have less than three degrees of freedom. It minimally has the or one yaw axis 142 for steering but one or more of the other axes 140, 144 can be absent and/or be locked at a given point in time in some implementations. The position of the yaw axis 142 can be offset from the geometric centre and/or not be closer to the rear of the primary unit 100 compared to the front of the secondary unit 102. Hence, the pitch axis 140 and the yaw axis 142 may not necessarily be at the same longitudinal position in other implementations. Other variants are possible as well.

In the illustrated example, the sequence in the positioning of the axes 140, 142, 144 is, starting from the primary unit 100 towards the secondary unit 102, the pitch axis 140, the yaw axis 142 and then the roll axis 144. This order was found to be particularly optimal for a wide range of applications. Nevertheless, other configurations and arrangements are possible. For instance, one could invert the order for a particular implementation. The exact order and position of the axes 140, 142, 144 can be different in other implementations. Although these axes intersect or nearly intersect at a common point in the illustrated example, they can be disposed differently in some implementations. Some or even all the axes 140, 142, 144 may not be orthogonal to another or to the others. Other variants are possible as well.

It should be noted that although the rear ends of the rear section 132 are pivotally attached to the secondary unit 102 in the illustrated example, the horizontal pivot axis around which these rear ends can pivot does not constitute the pitch axis. This additional transversal pivot axis is also not necessarily present in all implementations. For instance, among other things, it can be omitted when a secondary unit 102 has two ground-engaging wheels or if it has a transversal pivot axis between its upper chassis and the undercarriage, such as an undercarriage having a pair of skis or having more than one pair of wheels. An additional transversal pivot axis may sometimes still be present even if the secondary unit 102 includes pairs of skis or pairs of wheels, for instance when the front pair of skis or wheels are mounted on a subframe that can pivot around a substantially vertical axis to change its orientation like it is done for the front wheels of a conventional farm wagon. Such construction details would be readily understood by someone skilled in the art and need not to be further discussed herein.

The front section 130 of the steerable coupling linkage 106 can include an elongated front section frame 150 extending transversally in the widthwise direction, as shown. It is designed to form a relatively strong and rigid lightweight structure. The front section frame 150 can be attached to the housing 112 of the primary unit 100 using, for instance, a pair of opposite side plates 160 that are parallel to and facing one another, as shown in the illustrated example. The front section frame 150 can be pivotally mounted between these two side plates 160 and can pivot about the pitch axis 140 using a pitch axis mount, as shown. The pitch axis mount in this implementation includes corresponding pivot joints 162 extending between the opposite ends of the front section frame 150 and the side plates 160. Each side plate 160 can be rigidly attached to the exterior of the housing 112, for instance on a corresponding side surface near the rear end of the primary unit 100, as shown. Each of the illustrated side plates 160 can include a hemispheric base portion and an elongated upper portion extending at an acute angle in an upper rearward direction from the corresponding base portion thereof once it is mounted to the primary unit 100, as shown. The hemispheric bases of these side plates 160 can be bolted or otherwise attached to the outer lateral wall surface of the housing 112, for instance immediately above the rear axle of the primary unit 100, as shown in the illustrated example. Other configurations and arrangements are possible. The side plates 160 can have a completely different design in some implementations and/or be attached elsewhere. The side plates 160 can have one or more parts of the primary unit 100 attached thereon, such as guard plates or the like. The side plates 160 can be omitted in some implementations, for instance if there are already structures on the primary unit 100 to which the front section frame 150 or another part of the steerable coupling linkage 106 can be attached. Accordingly, the side plates 160 are not necessarily essential for the operation of the steerable coupling linkage 106. Other variants are possible as well.

The illustrated example includes a lever 164 rigidly attached over one end of the front section frame 150. The lever 164 is generally oriented towards the rear and can include a large angularly disposed knob at the free end thereof, as shown. The lever 164 can be useful for hand adjusting the angular position of the front section frame 150 around the pitch axis 140, for instance when an operator connects the subparts 136, 138. The lever 164 can keep the hand of the operator at an appropriate location. Other configurations and arrangements are possible. One can provide more than one lever. The lever 164 can be designed and/or positioned differently, for instance not including a knob. The lever 164 can also be omitted in some implementations. Other variants are possible as well.

The front section 130 can include a generic semi-spherical towing ball 166, as shown. In the illustrated example, the ball 166 has a main central axis that is substantially coincident with the yaw axis 142. The ball 166 can include, for instance, a bottom vertical threaded shank inserted through a central hole made on the top part of the front section frame 150. The ball 166 can be held on the opposite side by a nut and/or using another kind of mechanical arrangement. A towing ball such as the illustrated ball 166 is widely available. Among other things, it can be handy if the primary unit 100 is used for moving a conventional trailer, for instance a boat trailer, over a short distance at a location such as a beach, a boat ramp, etc., because another vehicle is unavailable or unable to achieve what the primary unit 100 can do at the given location. A conventional trailer generally has a front drawbar with a trailer hitch at its frontmost end. Such trailer hitch can be pivotally attached and secured onto the ball 166 when the rear section 132 of the illustrated steerable coupling linkage 106 is not present. The ball 166 otherwise constitutes an excellent robust anchoring point for the rear section 132 when the illustrated steerable coupling linkage 106 is fully assembled. Other configurations and arrangements are possible. For instance, the ball 166 can be positioned elsewhere on the steerable coupling linkage 106, be replaced by another element or even be entirely omitted in other implementations. The boat trailer is only one example, and many other kinds of trailers can be maneuvered using the ball 166. Other variants are possible as well.

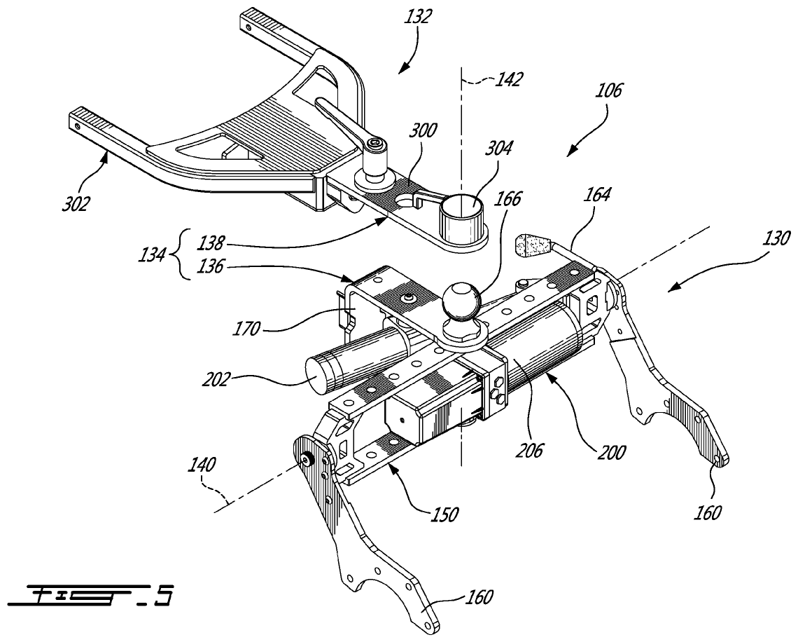

FIG. 5 is a view similar to FIG. 3 but where the subparts 136, 138 of the middle section 134 are detached.

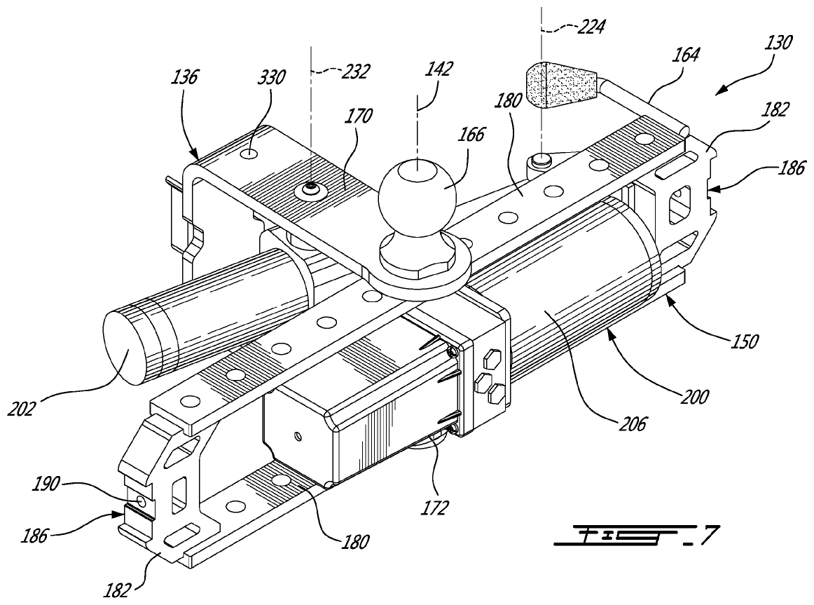

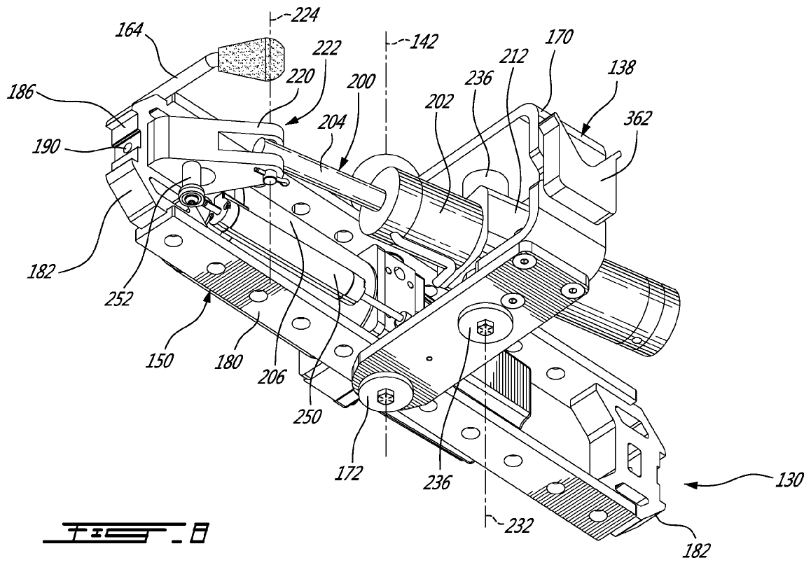

The bottom subpart 136 of the middle section 134 in the illustrated example includes a bottom subpart frame 170 that is coupled to the front section frame 150 of the front section 130. The bottom subpart frame 170 extends substantially vertically and is generally oriented towards the rear. The bottom subpart frame 170 can be generally U-shaped, as shown in this implementation, and can be made using one or more parts, for instance interconnected metallic workpieces. The free end of each branch of the bottom subpart frame 170 can be pivotally attached to the front section 130. In the illustrated example, the front end of the top branch of the bottom subpart frame 170 is pivotally attached over the top side of the front section frame 150 using a top pivot joint (not visible in the figures) and the front end of the bottom branch is pivotally attached under the bottom side of the front section frame 150 using a bottom pivot joint 172 (see FIGS. 7 and 8). These two pivot joints are coaxial with the yaw axis 142 in this implementation and form the yaw axis mount. The bottom subpart frame 170 can then pivot with reference to the front section frame 150 about the yaw axis 142. Since the ball 166 is also present in this implementation, the front end of the top branch of the bottom subpart frame 170 is positioned between the top side of the front section frame 150 and the underside of the base of the ball 166. Other configurations, arrangements and materials are possible. For instance, the bottom subpart frame 170 and/or the connections between the parts can be constructed differently. The bottom subpart frame 170 can be pivotally attached at a single pivot joint in some implementations. Other variants are possible as well.

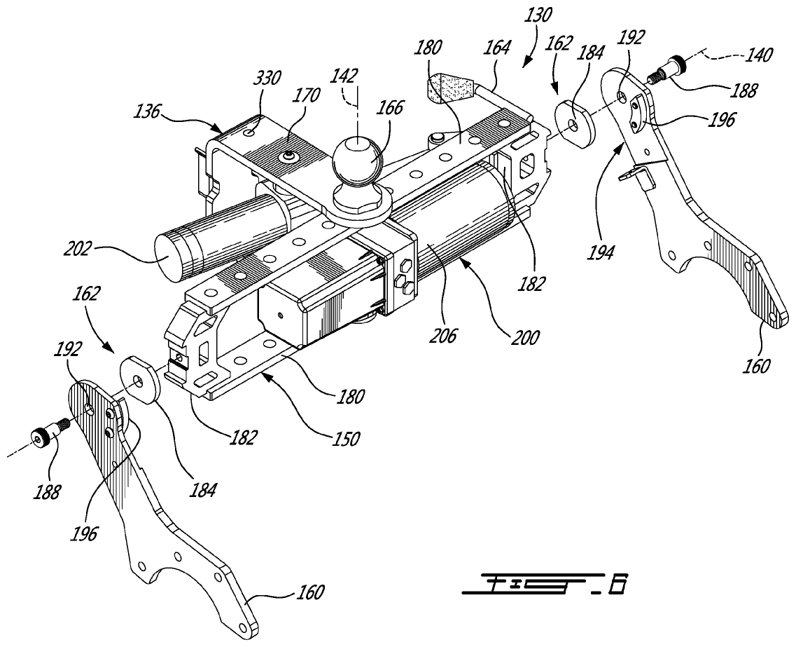

FIG. 6 is a front isometric and partially exploded top view illustrating only the front section 130 and the bottom subpart 136 of the middle section 134 shown in FIG. 3. FIG. 7 is an enlarged front isometric top view of some of the parts in FIG. 6.

The front section frame 150 can include a pair of spaced apart and parallel crossbar 180 having ends rigidly connected to opposite endpieces 182, as shown in the illustrated example. These crossbars 180 are in the form of elongated flat strips and can include a plurality of spaced apart holes. They are vertically spaced from one another, leaving a free space in which other components could be placed, as shown. Other configurations and arrangements are possible. The front section frame 150 can be configured differently, for instance have parts with other shapes and/or with no free space therein. The holes on the crossbars 180 of the illustrated example can be omitted in other implementations. Other variants are possible as well.

In the illustrated example, each endpiece 182, when in a neutral position, is oriented somewhat vertically. It is also located adjacent to a corresponding one of the side plates 160 when the steerable coupling linkage 106 is fully assembled and attached to the primary unit 100. Each pivot joint 162 of the pitch axis mount by which the front section frame 150 is pivotally attached to the primary unit 100 in this implementation includes a truncated flat washer 184 fitting into a lateral-facing seat 186 (see FIG. 7) provided on an outer side of the corresponding endpiece 182. It further includes a bolt 188 passing into a through hole 192 made across a top portion of the corresponding side plate 160 and also through the hole at the centre of the corresponding washer 184. The tip of the threaded shank of the bolt 188 is then inserted into a threaded bore 190 located at or near the centre of the corresponding seat 186 and transversally extending inside the endpiece 182. Each bolt 188 in this implementation has an unthreaded shank portion right under the bolt head for engaging the interior of the through hole 192 across the corresponding side plate 160. Other configurations and arrangements are possible. For instance, the pitch axis mount can be constructed differently and/or can include bearings, bushings, or other kinds of mechanical arrangements. It can be a transversally disposed rod around which the front section frame 150 pivots. Other variants are possible as well.

The illustrated example also includes a pitch limiter arrangement 194 to selectively limit the range of relative angular positions about the pitch axis 140. The pitch limiter arrangement 194 can have a right side and a left side, where a pivoting element can abut against one or more fixed elements at two opposite angular end positions. In the illustrated example, each side of the pitch limiter arrangement 194 includes an arc-shaped stopper 196 rigidly attached to the interior-facing surface at the top end of a corresponding one of the side plates 160. Each stopper 196 is positioned at a given radial distance from the through hole 192 and its inner side can engage or be very close to the outer rim of the corresponding washer 184. Also, the pivoting elements of the pitch limiter arrangement 194 in the illustrated example are the endpieces 182. Each stopper 196 is configured and disposed so that a portion of the endpieces 182 abuts against a corresponding one of their end faces at each angular end position, thereby preventing the front section frame 150 to pivot further in that direction about the pitch axis 140. Other configurations and arrangements are possible. For instance, the pitch limiter arrangement 194 can be constructed completely differently and can even be omitted entirely in other implementations. The pivoting elements can also be parts other than the endpieces. If desired, a locking mechanism can be provided to selectively hold the pitch angle at a neutral position or another, which could be useful in some situations. The stoppers 196 can be rigidly attached to the endpieces 182 in some implementations to cooperate with corresponding features provided, for instance, on the side plates 160. Other variants are possible as well.

As can be seen in the illustrated example, the steerable coupling linkage 106 includes a steering actuator mechanism 200 for actively controlling the steering direction of the articulated vehicle 104. The steering actuator mechanism 200 is responsive to command signals sent by a control system, for instance the joystick controller 126 and/or another arrangement or system. The steering actuator mechanism 200 can alter the relative angular position between the primary unit 100 and the secondary unit 102 with reference to the yaw axis 142, thereby allowing the articulated vehicle 104 to be steered when it is in motion. In general, the relative angular position can also be changed when the articulated vehicle 104 is stationary, i.e., not moving forward or rearward, thereby forcing them to pivot. The steerable coupling linkage 106 holds the angular position once the desired steering angle is reached.

The steering actuator mechanism 200 can be installed, among other things, across the free spaces provided within the front section and bottom subpart frames 150, 170, thus within the front and middle sections 130, 134, as shown in the illustrated example. The combination of these two adjacent free spaces forms a relatively large transversally extending zone that can be an excellent location for receiving a large part of the steering actuator mechanism 200 in this implementation. Such arrangement can increase the compactness of the assembly and although the steering actuator mechanism 200 is not protected from all sides and some parts extend out of the zone, the two frames 150, 170 still provide a good protective structure for the steering actuator mechanism 200. Other configurations and arrangements are possible. For instance, the steering actuator mechanism 200 can be located completely outside of the two frames 150, 170. Other variants are possible as well.

FIG. 8 is a rear isometric bottom view of the parts shown in FIG. 7.

The steering actuator mechanism 200 of the illustrated example includes a steering actuator 202. The illustrated actuator 202 is generally disposed and oriented in the transversal direction within the middle section 134, as shown. Even if the actuator 202 is not entirely parallel to the transversal direction when the two units 100, 102 are in registry with one another, it is nevertheless considered to be transversally disposed because the actuator 202 extends across the longitudinal axis of the primary unit 100. The forces generated by the actuator 202 are then exerted transversally, thus not towards the primary unit 100, like in the arrangement disclosed in WO 2019/104436 A1. Among other things, the transversal disposition of the actuator 202 increases the lengthwise compactness of the steering actuator mechanism 200 and can minimize the length of the front half of the steerable coupling linkage 106 extending out at the rear of the primary unit 100 when the subparts 136, 138 are disconnected. An increased compactness allows the primary unit 100 to fit in a smaller space during storage or when it is transported in another vehicle.

The steering actuator 202 can be a linear actuator, for instance a hydraulic actuator, as shown. Other configurations and arrangements are possible. Other kinds of actuator mechanisms can also be used, including other kinds of actuators. For instance, some implementations may use a pneumatic actuator or an electric actuator, or even actuators that are not linear actuators, depending on the requirements. The actuator 202 can be located elsewhere. The actuator 202 is substantially at the horizontal in the illustrated example, but this may not always be the case in all implementations. Other variants are possible as well.

In the illustrated implementation, the actuator 202 includes a cylinder and a reciprocating piston, located inside the cylinder, to which is connected a rectilinear actuator rod 204 extending out at one end of the cylinder. The steering actuator mechanism 200 includes a hydraulic pump unit 206 that generally extends parallel in the widthwise direction and that can use electrical energy to operate a motor powering an internal hydraulic pump. The hydraulic pump unit 206 can include a built-in fluid reservoir in addition to the internal pump and the electric motor. The pressurized fluid can be supplied to the actuator 202 through flexible pressure hoses or through another suitable arrangement. These pressure hoses are schematically depicted in FIG. 4 at 208. The cylinder of the actuator 202 in the illustrated example is rigidly attached to an outer support 212 that is pivotally connected within the bottom subpart 136 of the middle section 134 through opposite top and bottom pivot joints 236. The cylinder of the actuator 202 can then pivot around a substantially vertical axis 232. Other configurations and arrangements are possible. Among other things, the hydraulic pump unit 206 can be configured and/or constructed differently. The actuator 202 may receive pressurized fluid from a hydraulic pump unit located elsewhere on the primary unit 100 or even elsewhere on the articulated vehicle 104. The actuator 202 can be supported using another kind of arrangement. The actuator 202 could be oriented in the opposite direction. Other variants are possible as well.

The free end of the actuator rod 204 can be pivotally attached to a swivel member 220 at a pivot joint 222, as shown in the illustrated example. The swivel member 220 in this implementation includes a triangular-shaped body rigidly attached to the rear side of one of the endpieces 182. The pivot joint 222 of the swivel member 220 has a substantially vertical pivot axis 224 that is longitudinally offset in position towards the rear with reference to the yaw axis 142 to increase the leverage effect in this implementation. Other configurations and arrangements are possible. Among other things, the swivel member 220 can be located on the right side of the primary unit 100 instead of the left side, as shown, and the actuator rod 204 of the actuator 202 would then be positioned in the other direction. The actuator 202 can also be configured to have the end of the cylinder next to the swivel member 220. The swivel member 220 can have another shape and can even be omitted in some implementations. Other variants are possible as well.

In use, extending and retracting the actuator rod 204 forces the bottom subpart frame 170 to pivot about the yaw axis 142 in both directions with reference to a neutral position, which neutral position is the position when the articulated vehicle 104 can travel in a straight line when it is on a flat and levelled horizontal ground surface. Changing the position of the actuator 202 to steer the articulated vehicle 104 can be done regardless of the relative angle between the primary unit 100 and the secondary unit 102 with reference to the pitch axis 140 and also with reference to the roll axis 144 if there are freedom of movements around them.

The steerable coupling linkage 106 can include a position sensor 250 to measure the steering angle in real time, as shown in the illustrated example. The position sensor 250 has a telescopic construction and extends substantially horizontally in this implementation. One end of the position sensor 250 can be pivotally attached to the front section frame 150, for instance to a pin 252 extending vertically under the swivel member 220, and its opposite end can be pivotally attached to the bottom subpart frame 170, as shown. The data from the position sensor 250 can be sent to the control system, for instance through the wired connection 210, and/or to any another system or module, in the form of signals indicative of the steering angle once they are processed. This information can be used for various purposes, such as providing feedback to the operator and/or to an autonomous or semi-autonomous driving module, for instance one programmed with a software that can operate the articulated vehicle 104 without any human intervention and/or that can assist the human operator. Other configurations and arrangements are possible. The position sensor 250 can be constructed and/or can be positioned differently. The information about the steering angle could be available through another sensor or system. For instance, some actuators can already include a built-in position sensor or the like. The steering angle could be obtained indirectly through a completely different sensor and/or method. The position sensor 250 can even be entirely omitted in other implementations if obtaining data about the steering angle is not required. Other variants are possible as well.

If desired, a selector such as a mechanical or electrical switch, can be provided to activate or deactivate the hydraulic pump unit 206 through a bypass mode. A bypass mode allows the piston to move freely within the cylinder of the actuator 202. Normally, like in many hydraulic systems, the piston in this implementation will otherwise remain in the same position even when the hydraulic pump unit 206 is unpowered. Having a bypass mode can be useful when, for instance, one or more other articulated vehicles 104 must be towed behind the units 100, 102 and that these additional units 102 must passively follow the direction of the units 100, 102 at the front. The bypass mode can also be useful when the subparts 136, 138 must be manually repositioned by someone, for instance the operator, to form the articulated vehicle 104. Other configurations and arrangements are possible. Other kinds of selectors can be used, and/or a remote control of the bypass mode can be provided. The bypass mode can be omitted in some implementations. Other variants are possible as well.

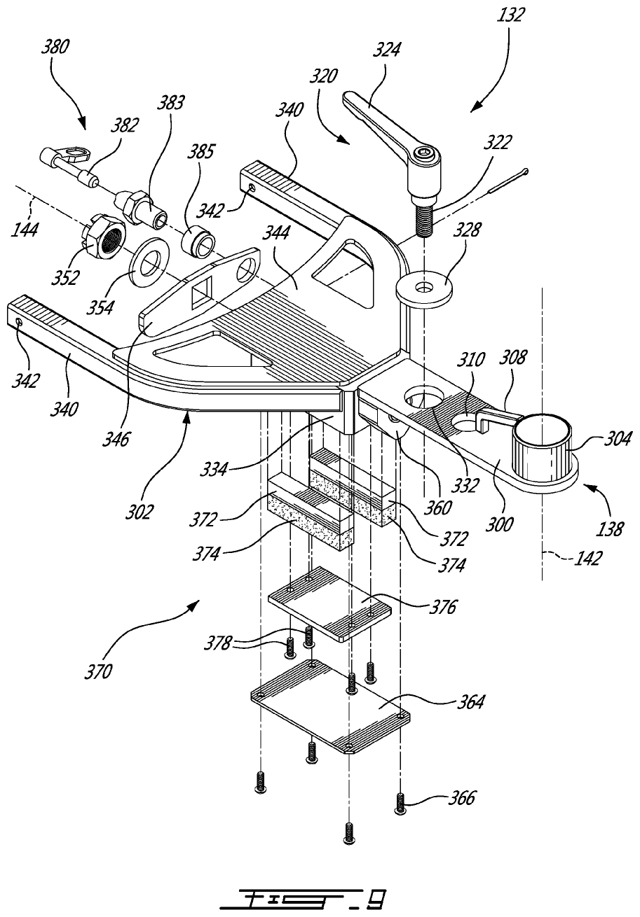

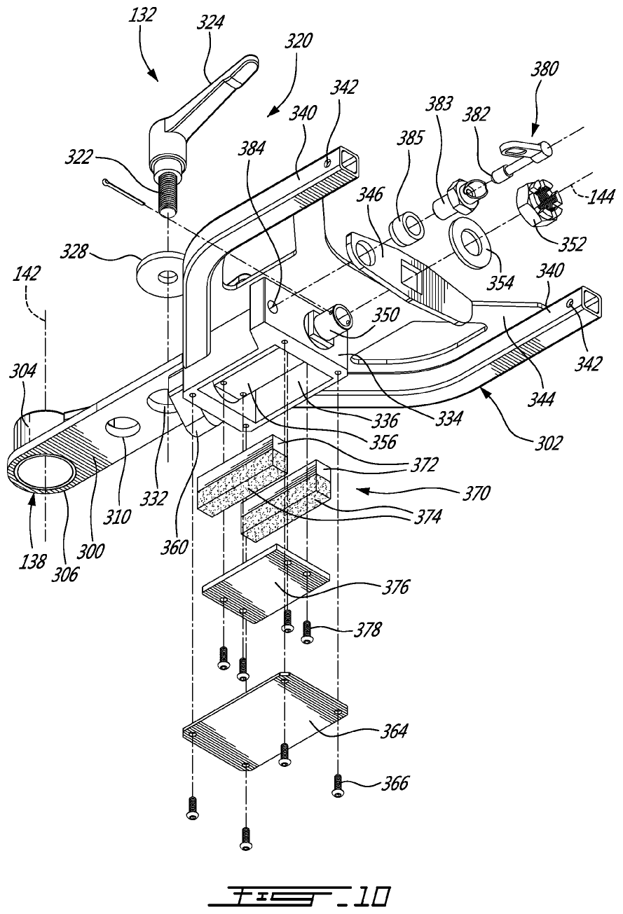

FIG. 9 is a front isometric and partially exploded top view illustrating only the top subpart 138 of the middle section 134 and the rear section 132 shown in FIG. 3. FIG. 10 is a rear isometric and partially exploded bottom view of the parts shown in FIG. 9.

The top subpart 138 of the middle section 134 in the illustrated steerable coupling linkage 106 includes a longitudinally extending front member 300 and this front member 300 is pivotally connected to a rear subassembly 302 that is part of the rear section 132. The front member 300 in this implementation is a generally flat and rectilinear rigid bar having an underside that can engage the generally flat top side of the bottom subpart frame 170 when the subparts 136, 138 are assembled. The illustrated top subpart 138 also includes a vertically extending sleeve 304 rigidly attached onto the front member 300. This sleeve 304 is in registry and coextensive with a first through hole 306 located near the frontmost end of the front member 300. The sleeve 304 and the first through hole 306 are configured and disposed to receive the ball 166 extending vertically from a top surface of the bottom subpart frame 170. The interior of the sleeve 304 can fit relatively tightly around the spherical portion of the ball 166 and also around its base. The illustrated rear section 132 further includes an elongated rod-like reinforcing support 308 longitudinally extending on an upper side of the front member 300 thereof. The support 308 of this implementation has a front end rigidly attached to the outer surface of the sleeve 304, at or near its top edge, and a rear end rigidly attached to a rearward location on the top surface of the front member 300. The support 308 can also be used as a handle, as an attachment point for something else, etc. Other configurations and arrangements are possible. The front member 300 can be constructed differently. Still, the sleeve 304 and/or the support 308 can be omitted in other implementations. Other variants are possible as well.

The illustrated front member 300 includes a second through hole 310. The second through hole 310 is simply present in this implementation to provide a clearance for the head of a fastener and a corresponding washer of the pivot joint 236 located on a top side of the bottom subpart frame 170 (see FIG. 8). Other configurations and arrangements are possible. For instance, it is possible to use only a bore or another kind of cavity in other implementations. The second through hole 310 can be omitted in other implementations if the fastener is absent or does not extend beyond the top surface, for instance because it is located in a chamfer or the liked. Other variants are possible as well.

The illustrated steerable coupling linkage 106 includes a retention arrangement 320 removably securing the subparts 136, 138 of the middle section 134. The retention arrangement 320 is essentially a locking mechanism firmly holding the parts together in a fully locked position and that can help in achieving the alignment when the connection is made. It includes a threaded rod or screw 322 that can be hand-operated using a handle 324 affixed to the top end thereof in this implementation, thereby allowing the retention arrangement 320 to be operated and put into the locked position without an external tool. The threaded rod 322 can be inserted into a corresponding vertically oriented threaded hole 330 made through the top side of the bottom subpart frame 170. The threaded hole 330 can be seen, for instance, in FIGS. 6 and 7. The retention arrangement 320 includes a washer 328 in this implementation. This washer 328 engages the bottom side of the handle 324. The retention arrangement 320 is put in a released, or fully unlocked position, when the subparts 136, 138 can be moved away from one another. Other configurations and arrangements are possible. For instance, other kinds of arrangements can be used, including some that do not include a threaded rod. Other variants are possible as well.

A third through hole 332 (FIG. 9) can be provided across the front member 300, near the rear end thereof, for accessing the threaded hole 330, as shown in this implementation. The outer diameter of the washer 328 is larger than that of the third through hole 332. The third through hole 332 is also made much larger than the diameter of the threaded rod 322 to facilitate access to the entry of the threaded hole 330 when the proper alignment is not obtained yet. In use, tightening the threaded rod 322 of the retention arrangement 320 will generate a retention force compressing the washer 328 over the surface around the third through hole 332 on the front member 300. The retention arrangement 320 will hold and lock the subparts 136, 138 together once the threaded rod 322 is firmly tightened. Other configurations, arrangements and materials are possible. Among other things, other kinds of retention arrangements or mechanisms can be used. The handle 324 and/or the washer 328 and/or the threaded hole 330 can be omitted in other implementations. Some implementations can include a ratchet-like mechanism at the top end of the threaded rod 322 instead of the plain handle 324 to facilitate tightening and loosening. The retention arrangement 320 could consist of one or more fasteners, such as bolts, screws, or others, installed and removed using an external tool. The retention arrangement 320 can be omitted in some implementations, for instance when the steerable coupling linkage 106 cannot be subdivided in normal use, or for other reasons. Other variants are possible as well.

The rear subassembly 302 of the rear section 132 can include a rigid rectangular casing 334 to which other parts can be connected, as shown in the illustrated example. The casing 334 includes an inner compartment 336 that can be seen in FIG. 10. The compartment 336 in this implementation has a bottom-facing open side that can be closed by a lid 364 using fasteners such as screws 366 or the like. Other configurations and arrangements are possible. For instance, the casing 334 can be shaped, positioned, and/or constructed differently. The open side of the casing 334 can be located on the top side in other implementations. The lid 364 can be otherwise secured and can even be irremovable attached to the rest of the casing 334. The casing 334 can be omitted in some implementations. Other variants are possible as well.

The illustrated rear subassembly 302 further includes two side bars 340 rigidly attached on opposite lateral sides of the casing 334 and forming a U-shaped structure, the rear part of these side bars 340 extending substantially parallel to one another in the longitudinal direction. Their rearmost end in this implementation is made removably attachable to the corresponding hinges 128 (see FIGS. 1 and 2) using transversal holes 342. This rear subassembly 302 also includes a gusset plate 344 rigidly attached, for instance by welding and/or through fasteners, over the casing 334 and over a portion of the side bars 340 for reinforcing the structure. Other configurations and arrangements are possible. The rear subassembly 302 can be designed differently and, as aforesaid, can include only a single connection point at the rearmost end. Some of the above-mentioned parts can be modified or can even be omitted, including the gusset plate 344. Other variants are possible as well.

A longitudinally disposed shaft 350 extends across the casing 334, at or near its centre, and is pivotally supported to its front and rear walls in the illustrated example. The longitudinal axis of the shaft 350 corresponds to the roll axis 144 in this implementation. The front end of the shaft 350 extends or can be reached through the front wall of the casing 334. The rear end of the shaft 350 extends out through the rear wall of the casing 334, and a nut 352 is secured to a corresponding threaded portion at the rearmost end of the shaft 350 in this implementation. A washer 354 is also provided between the outer surface of the rear wall and the nut 352, and the nut 352 can be locked by a cutter pin or using another arrangement. The pivot joints connecting the shaft 350 to the walls of the casing 334 can be constructed and/or positioned differently. They can include for instance a bearing or a bushing arrangement. Other configurations and arrangements are possible. For instance, the nut 352 and/or the cutter pin can be replaced by another element or be omitted in some implementations. Other variants are possible as well.

In the illustrated example, shown in FIGS. 9 and 10, the front member 300 is in a torque-transmitting engagement with shaft 350 and in the rear section 132. The rear subassembly 302 can pivot around the shaft 350. The front member 300 is rigidly attached to the frontmost end of the shaft 350 through a first supporting element 360 in this implementation. These parts can be welded together, for instance. Other kinds of connections are possible. The illustrated first supporting element 360 is also rigidly or otherwise attached to the front end of the shaft 350 to create a torque-transmitting engagement between them. The first supporting element 360 includes a hole through which the frontmost end of the shaft 350 can be inserted and in which they are mutually attached. Other configurations and arrangements are possible. The connections between the shaft 350 and the first supporting element 360 and/or between the front member 300 and the first supporting element 360 can be constructed and/or positioned differently. Other variants are possible as well.

In use, the first supporting element 360 will pivot with reference to the front wall of the casing 334 in this implementation when the orientation changes about the roll axis 144. The first supporting element 360 includes a V-shaped bottom side that is configured and disposed to engage a corresponding V-shaped upper side provided on a second supporting element 362 in this implementation. This second supporting element 362 is rigidly attached on a rear-facing surface at the back of the bottom subpart frame 170, as shown for instance in FIG. 8. The two mating surfaces of the supporting elements 360, 362 in this implementation have rounded off shapes. The supporting elements 360, 362 are positioned so that these surfaces are brought into engagement with one another when, or slightly before, the front member 300 is put over the bottom subpart frame 170. They will remain in that position thereafter. These complementary supporting elements 360, 362 can be very helpful to facilitate the alignment of the subparts 136, 138 when they are being attached, particularly on a rough terrain or elsewhere where the ground surface is uneven. Other configurations and arrangements are possible. For instance, the supporting elements 360, 362 can be designed differently or even be omitted in some implementations. Other variants are possible as well.

Generally, to achieve the connection in the illustrated example, the front member 300 and the bottom subpart frame 170 are first longitudinally aligned, for instance by repositioning at least one among the primary unit 100 and the secondary unit 102, and/or by changing the orientation of the bottom subpart frame 170 about the yaw axis 142, either using the steering actuator mechanism 200 to move it in a motorized manner or moving it by hand once a bypass mode is activated. When a proper alignment is found, the front member 300 can be set over the upper side of the bottom subpart frame 170. It is placed so that the ball 166 can enter the first through hole 306. The spherical shape on the upper end of the ball 166 can facilitate the insertion and guidance of the front member 300 at this moment. Moving down the front member 300 into engagement with the bottom subpart frame 170 will bring the first and second supporting elements 360, 362 into engagement. The V-shaped mating surfaces can correct any remaining misalignment of the front member 300. The retention arrangement 320 can then be set to firmly hold the two subparts 136, 138 once fully tighten. The supporting elements 360, 362 in this implementation also prevent the front member 300 from being subjected to the entire vertical loads when the articulated vehicle 104 is operated. Other configurations and arrangements are possible. The procedure followed for assembling the subparts 136, 138 can be different from the one described above. Other variants are possible as well.

It should be noted that the sleeve 304, among other things, can often facilitate the handling by operators and their crew when the units 100, 102 are being attached to form the articulated vehicle 104 since it is easy to clean, unlike a conventional trailer hitch. Conventional trailer hitches can be difficult to clean when they are packed with solidified snow or ice, or even mud, for instance after being placed on the ground for some time. Such materials, if they are inside the sleeve 304, can generally be quickly removed simply by inserting the sleeve 304 over the ball 166 and the ball 166 will push them out.

The illustrated steerable coupling linkage 106 includes a roll damper mechanism 370 located within the casing 334. The roll damper mechanism 370 can have multiple functions, such as limiting the range of angular positions about the roll axis 144, reducing the amplitude and angular speed when approaching one of the limit positions and/or mitigating shocks once an angular end position is reached. The roll damper mechanism 370 in this implementation includes a pair of rigid elongated spacers 372 and also a pair of cushions 374 made of a resilient material that can withstand intense compression. Each cushion 374 engages the bottom side of a corresponding one of the spacers 372. The spacers 372 and the cushions 374 extend parallel to the shaft 350 on a corresponding side thereof. The illustrated roll damper mechanism 370 also includes a rectangular and flat damper plate 376 rigidly attached to a bottom flat segment 356 under the shaft 350, for instance using screws 378. The flat segment 356 is located inside the compartment 336 and can be a part machined or otherwise created on the shaft 350 during manufacturing. The damper plate 376 is larger in width than the diameter of the shaft 350 and is centred thereon. The damper plate 376 is smaller than the internal width of the compartment 336. The damper plate 376 extends parallel to the top surface inside the compartment 336 when the orientation corresponds to the neutral position. In use, the damper plate 376 will engage or will be engaged by the bottom side of the cushions 374 and compress a corresponding one of the cushions 374 when the angular position changes. Only one of the cushions 374 will be compressed at a time. Each cushion 374, when compressed, will have a spring-like effect, and will damp the angular motions. Other configurations and arrangements are possible. The roll damper mechanism 370 can be constructed and/or positioned differently. For instance, it can be located on the upper side of the casing 334 in other implementations. The spacers 372 can be positioned differently or even be omitted. The cushions 374 can be replaced by other elements, for instance one or more springs. The roll damper mechanism 370 may have fewer characteristics in some implementations, and it can even be omitted in others. The damper plate 376 can be designed differently or be replaced by another component. Other variants are possible as well.

The illustrated steerable coupling linkage 106 further includes a roll locking arrangement 380 that can lock the angular position about the roll axis 144. This can be useful in some situations, for instance when having a freedom of movement about the roll axis 144 could cause the primary unit 100 and/or the secondary unit 102 to overturn on a very rugged terrain. The roll locking arrangement 380 can be activated to prevent or minimally to significantly limit the roll motion. In the illustrated example, the roll locking arrangement 380 includes a pin 382 that can cooperate with a hole 384 provided on a lateral extension of the rear wall of the casing 334. The roll locking arrangement 380 in this implementation includes a spring-loaded positioning mechanism 383 packaged as in socket-like unit and that is attached to a transversally extending back plate 346 through an annular holder 385 inside into a through-hole. The back plate 346 has a central square-shaped aperture tightly fitting over the end of a rear portion of the shaft 350 extending from the casing 334. The back plate 346 is engaged on the rear side by the washer 354. The pin 382 will usually be kept out of the hole 384 by the positioning mechanism 383, but it can be released by the operator when required, for instance by moving the lever or knob on the opposite end of the pin 382. The pin 382 not be immediately in registry with the hole 384 but will enter therein as soon as the angle is right, namely when it is at the neutral position. This feature can be very useful when if roll locking arrangement 380 is activated while the articulated vehicle 104 is in motion. Other configurations and arrangements are possible. For instance, at least some of the parts of the roll locking arrangement 380 and/or of its positioning mechanism 383 can be constructed and/or be positioned differently. The manual operation of the roll locking arrangement 380 can be replaced or can further include a remotely controlled mechanized actuation. The roll locking arrangement 380 can be omitted in some implementations. Other variants are possible as well.

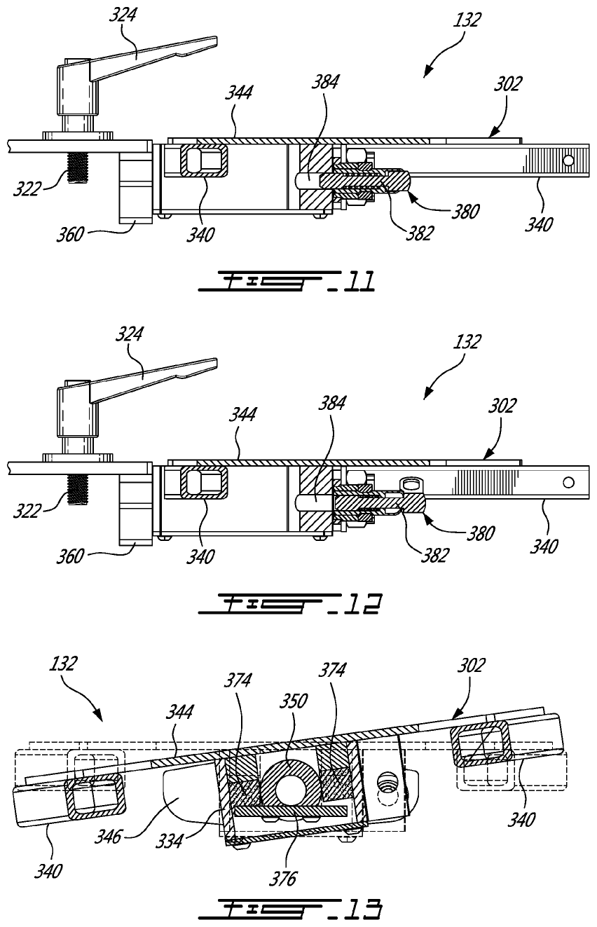

FIGS. 11 and 12 are longitudinal cross-section views illustrating the operation of the roll locking arrangement 380 in the steerable coupling linkage 106 shown in FIG. 3. FIG. 11 illustrates the roll locking arrangement 380 in the locked position. The pin 382 is then inserted far enough within the casing 334 to extend across the hole 384. FIG. 12 illustrates the pin 382 being out of the hole 384 and this corresponds to the unlocked position where the pivoting motion around the roll axis 144 is possible. The parts are then at a neutral position.

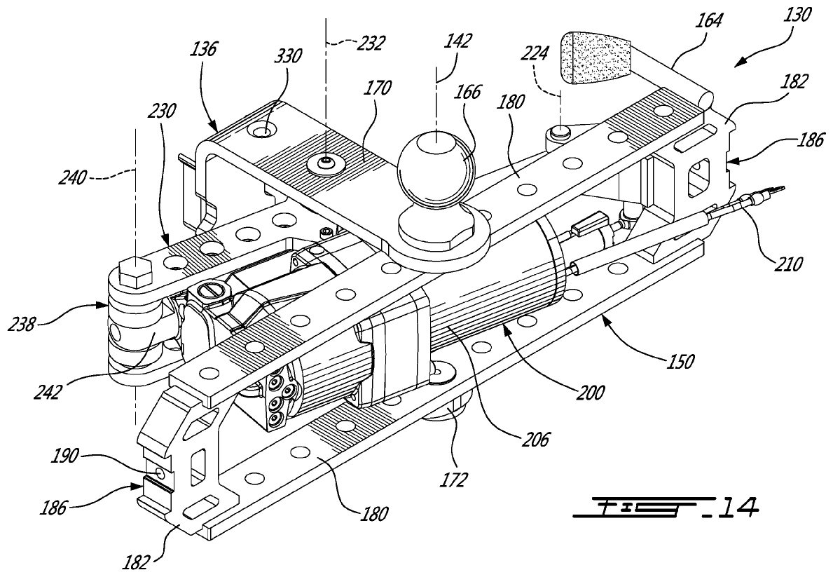

FIG. 13 is a transversal cross-section view made across the rear section 132 and illustrating the operation of the roll damper mechanism 370 in the steerable coupling linkage 106 shown in FIG. 3. FIG. 13 illustrates what happens when there is no longer an angular alignment between the top subpart 138 and the rear subassembly 302 with reference to the roll axis 144. The roll locking arrangement 380 is unlocked at this point. In this implementation, the casing 334 pivots while the damper plate 376 remains in the same position, namely at the horizontal in the figure. The cushion 374 at the left in the figure (corresponding to the right side of the articulated vehicle 104) is compressed against the top side of the damper plate 376. The same cushion 374 on the opposite side (on the right side in the figure) will be compressed in a similar way when the parts rotate towards the other side. Other configurations and arrangements are possible.

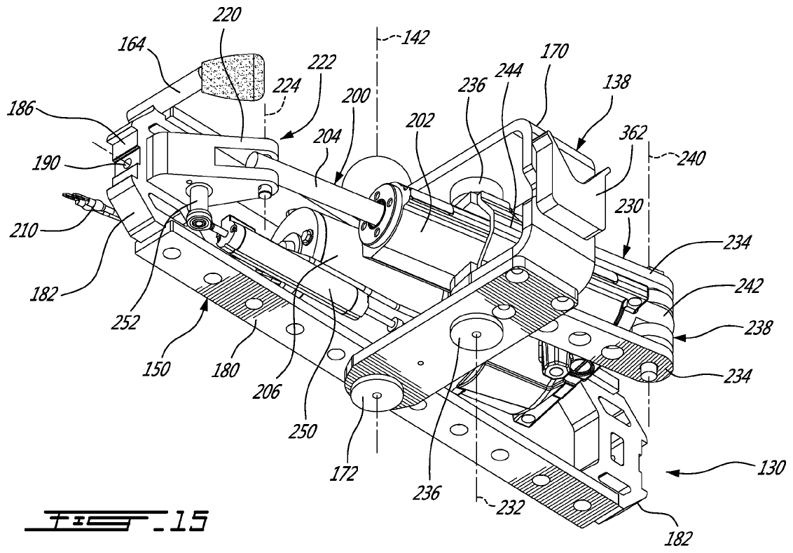

FIGS. 14 and 15 are views similar to FIGS. 7 and 8, respectively, but illustrating variants thereof. They show that the steering actuator mechanism 200 can be in the form of an electro-hydraulic actuator package. It includes a self-contained compact hydraulic pump unit 206 that is generally extending parallel and immediately adjacent to the actuator 202. The compact hydraulic pump unit 206 can be similar or even identical to one often used for tilting marine outboard motors, having for instance a built-in fluid reservoir and being capable of selectively supplying pressurized hydraulic fluid on each side of the piston for controlling its position, thus the elongation of the actuator rod 204. It can use electrical energy supplied through a wired connection 210 to operate a motor powering an internal hydraulic pump. Other configurations and arrangements are possible.

The cylinder of the actuator 202 shown in FIGS. 14 and 15 is supported by a laterally extending subframe 230. This subframe 230 has one end that can pivot about a first substantially vertical axis 232 located at or near the centre of the bottom subpart frame 170. The subframe 230 pivotally supports the actuator 202 and is part of the steering actuator mechanism 200. It is configured and disposed so that the cylinder has sufficient space and freedom of movement to pivot when the actuator rod 204 extends or retracts so as to change the steering angle of the articulated vehicle 104. The free end of the actuator rod 204 can be pivotally attached to a swivel member 220 at a pivot joint 222, as shown. The illustrated swivel member 220 also includes a triangular-shaped body rigidly attached to the rear side of one of the endpieces 182. The pivot joint 222 of the swivel member 220 has a substantially vertical pivot axis 224 that is longitudinally offset in position towards the rear with reference to the yaw axis 142 to increase the leverage effect in this implementation. The subframe 230 in the illustrated example includes two vertically spaced-apart crossbars 234 extending somewhat parallel to the axis of the actuator 202. They each have one end pivotally connected to a corresponding pivot joint 236 coaxially disposed with reference to the first vertical axis 232 in this implementation. This subframe 230 also includes a lateral hinge member 238 to which a free end of each crossbar 234 is pivotally or otherwise attached. The hinge member 238 can pivot about a second substantially vertical axis 240 that is on the other side of the bottom subpart frame 170 with reference to the axis 232. The subframe 230 in this implementation further includes an arm 242 having one end rigidly or otherwise attached to or near the end of the cylinder of the actuator 202, and an opposite end pivotally or otherwise attached to the axle of the hinge member 238. The subframe 230 includes an arc-shaped rigid strut 244 vertically extending between the crossbars 234 near the first vertical axis 232 to increase the structural rigidity in this implementation. Other configurations and arrangements are possible. For instance, other kinds of constructions or parts are possible. The subframe 230 can be designed to support only the cylinder of the actuator 202 and thus, the hydraulic pump 206 or an equivalent device can be located elsewhere, including within the front section frame 150. As aforesaid, the actuator 202 is not necessarily a hydraulic actuator. At least some of the parts mentioned above can be modified or even be omitted. Other variants are possible as well.

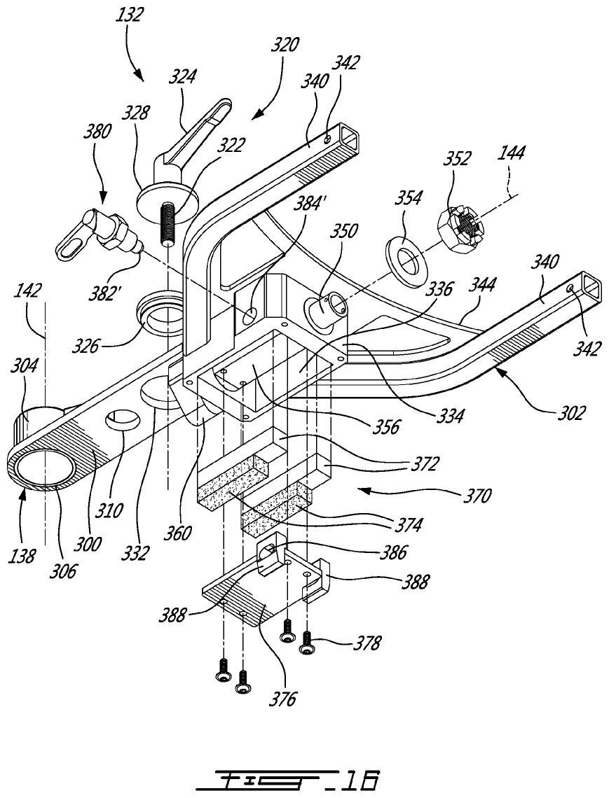

FIG. 16 is a view similar to FIG. 10 but illustrating variants thereof.

As can be seen, the retention arrangement 320 in this implementation includes a resilient annular fitting 326, for instance made of a rubber-like material or another kind of flexible material, provided as an intervening element between the washer 328 and the top surface surrounding the rim of the third through hole 332. The resilient fitting 326 can be helpful, among other things, to compensate any small misalignment between the subparts 136, 138 when they are being tightened. The resilient fitting 326 can also prevent, minimally to some extent, the threaded rod 322 from loosening by itself due to shocks and vibrations when the articulated vehicle 104 is in motion. Other configurations, arrangements and materials are possible.

In the implementation shown in FIG. 16, the roll locking arrangement 380 is located on the side of the casing 334. It includes a pin 382′ and the roll locking arrangement 380 is secured into a hole 384 provided near the rear edge of one of the lateral walls of the casing 334. This wall can be made thicker than the others in this implementation to increase the solidity, as can be seen in FIG. 16.

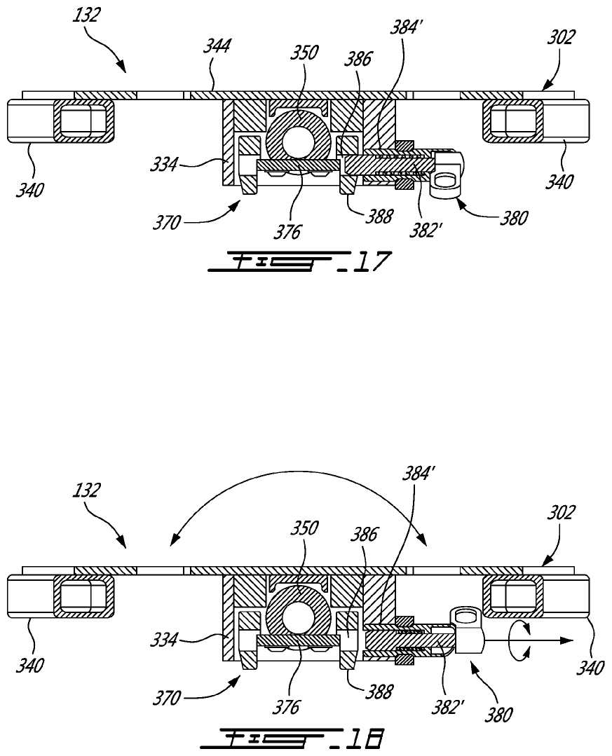

FIGS. 17 and 18 are transversal cross-section views illustrating the operation of the roll locking arrangement 380 in the steerable coupling linkage 106 shown in FIG. 16. As can be seen, the free end of the pin 382′ can cooperate with an aperture 386 provided across a corresponding holding block 388. There are two opposite holding blocks 388 in this implementation and they are positioned near the rear end of corresponding lateral edges of the damper plate 376. They are designed with a somewhat flat upper face to directly engage the bottom side of the spacers 372 near an angular limit position because the cushions 374 are made shorter at the end of the illustrated example. The roll locking arrangement 380 can be turned by the operator using an outer knob or handle, for instance when the articulated vehicle 104 is stopped, to change the position of the pin 382′ with reference to the aperture 386. Other configurations and arrangements are possible. For instance, at least some of the parts of the roll locking arrangement 380 can be constructed and/or be positioned differently. The thicker wall can be omitted in other implementations. Other variants are possible as well.

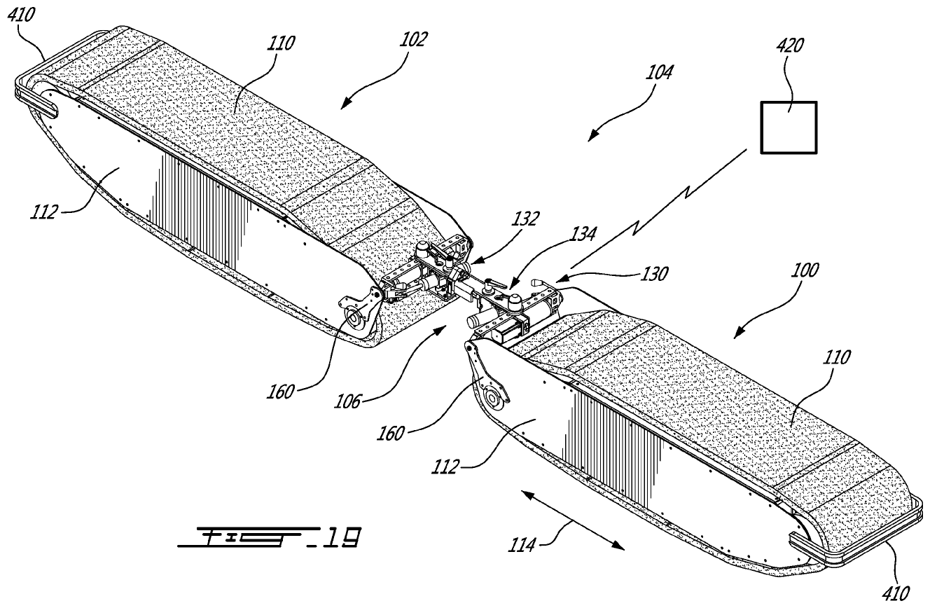

FIG. 19 is an isometric top view of another example of a steerable coupling linkage 106 as proposed herein. This steerable coupling linkage 106 is well adapted for use in an articulated vehicle 104 formed by two compact apparatuses connected in tandem. One apparatus in this example is considered to be the primary unit 100 and the other is the secondary unit 102. Both apparatuses 100, 102 are oriented opposite to one another in this implementation, namely that the two apparatuses set back to back. Such configuration can be useful for some purposes, for instance when more motive power is required. It is also fully reversible, meaning that the roles of the two apparatuses 100, 102 are interchangeable. Both apparatuses 100, 102 include a “front” section 130 and a bottom subpart 136 similar to the implementation depicted for instance in FIG. 3. Hence, they both have actuators for changing the steering angle but generally, for the sake of simplicity, only one of them is powered at a time and the other is locked in the neutral position. The resulting steerable coupling linkage 106 is a fusion of two basic coupling linkages 106 but where some parts are shared to minimize the spacing between the units and reduce part count. Variants are nevertheless possible.

The articulated vehicle 104 of FIG. 19 can be used as illustrated or, if desired, with one or more additional units (not shown). For instance, the additional unit or units can be attached using a connector or hitch (not shown) provided on one of the bumpers 410 of the apparatuses 100, 102. Also, FIG. 19 shows the articulated vehicle 104 being remotely controlled by an operator through a remote-control system 420, for instance using a wireless communication link, as schematically shown. The remote-control system 420 can include a satellite, a flying aircraft, a ground antenna, etc. Other configurations and arrangements are possible. Among other things, the operator can be located in an additional unit or be next to the articulated vehicle 104. Other variants are possible as well.

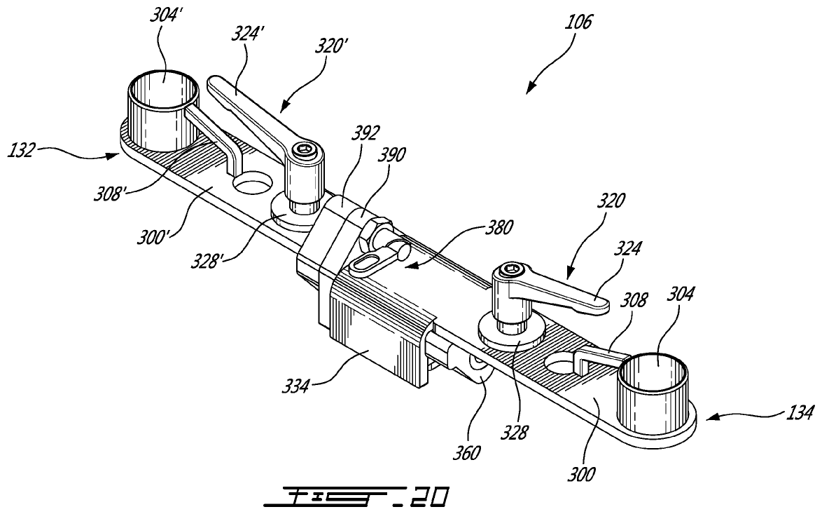

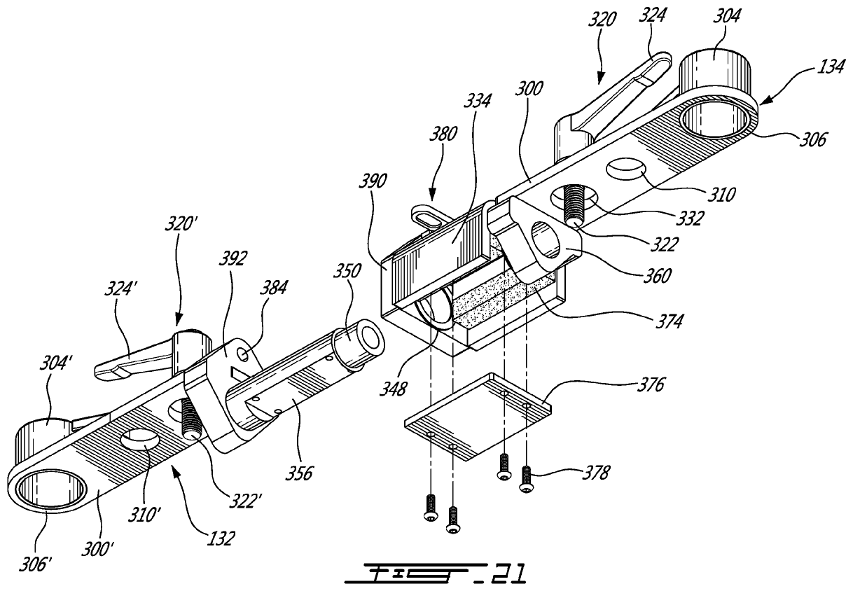

FIG. 20 is a front isometric top view of a portion of the steerable coupling linkage 106 shown in FIG. 19. FIG. 21 is a rear isometric and partially exploded bottom view of the parts shown in FIG. 20.

The steerable coupling linkage 106 includes, among other things, a front section 130 and a bottom subpart 136 as already described and that are not shown in FIGS. 20 and 21. These figures show, in the context of FIG. 19, the rear section 132 and a portion of the middle section 134, which portion is essentially an equivalent of the top subpart 138 like in the previous examples. Nevertheless, other configurations and arrangements are possible.

The illustrated steerable coupling linkage 106 includes two “front” members, namely a front member 300 and its equivalent member 300′ that is part of the rear section 132. It should be noted that the terms “front” and “rear” must be understood in the proper context, for instance in the context of the articulated vehicle 104 in FIG. 19. As can be appreciated by someone skilled in the art, the “front” can become the “rear” when the travel direction is inverted. Moreover, as aforesaid, a primary unit 100 can be used to push a secondary unit 102, including a secondary unit 102 that is not like the one shown in FIG. 19. The same steerable coupling linkage 106 can be used. References to “front” and “rear” parts, and any related words or expressions, are only for the sake of explanation and they do not necessarily signify that the front must always be oriented towards the forward travel direction.

As can be seen in FIGS. 20 and 21, both ends of the illustrated portion of the steerable coupling linkage 106 have sleeves 304, 304′, first through holes 306, 306′, supports 308, 308′, second through holes 310, 310′, and retention arrangements 320, 320′ with corresponding threaded rods 322, 322′, handles 324, 324′ and washers 328, 328′. The steerable coupling linkage 106 includes a first supporting element 360 rigidly attached under the front member 300. Like the first supporting element 360 from the previous examples, this first supporting element 360 includes a rounded-off V-shaped bottom side configured and disposed to engage the V-shaped upper side provided on a corresponding second supporting element 362 (see for instance FIG. 8) that is rigidly attached on what the equivalent of the bottom subpart frame 170 for the primary apparatus 100 in FIG. 19 is. Other configurations and arrangements are possible. Among other things, one or more among the above-mentioned components can be different from what is shown and/or described, and one or more can be omitted in some implementations. Other variants are possible as well.

The casing 334 of the illustrated example is rigidly attached at one end of the front member 300, namely the end opposite to the sleeve 304. This steerable coupling linkage 106 includes a shaft 350 (see FIG. 21) and this shaft 350 is rigidly connected to the rear section 132, thus to the member 300′. The roll damper mechanism 370 is thus configured differently compared to that of the previous examples, but it operates in a similar fashion. This configuration is also something that can be implemented in the previous examples. Other configurations and arrangements are possible. Among other things, the roll damper mechanism 370 can be constructed and/or positioned differently, for instance be positioned on the top side instead of the bottom as shown. The roll damper mechanism 370 can be omitted. Other variants are possible as well.

Still, the casing 334 of the example illustrated in FIGS. 20 and 21 is closed on its rear side by an end plate 390 that is rigidly attached thereon. The outer flat side of this end plate 390 is configured and disposed to engage the outer flat side of a supporting element 392 that is immediately adjacent to it in this version of the steerable coupling linkage 106. The supporting element 392 has a rounded-off V-shaped bottom side and its function is similar to that of the first supporting element 360, namely to engage the V-shaped upper side of a corresponding second supporting element 362 that is rigidly attached on what the equivalent of the bottom subpart frame 170 for the secondary apparatus 102 in FIG. 19 is. The end plate 390 and its adjacent supporting element 392 can pivot with reference to one another about the longitudinal axis of the shaft 350, this longitudinal axis corresponding to the roll axis 144 shown in the previous examples. There is also a roll locking arrangement 380 in this implementation, and it includes parts attached near the upper end of the end plate 390. The roll locking arrangement 380 extends longitudinally and the corresponding hole 384 for its locking pin (not shown) is provided on the supporting element 392, as shown in FIG. 21. Other configurations and arrangements are possible. Among other things, one or more the above-mentioned components can be different from what is shown and/or described, and one or more can be omitted in some implementations. The roll locking arrangement 380 can be constructed and/or positioned differently, and even be omitted. Other variants are possible as well.

In this implementation, the rear end of the shaft 350 is rigidly attached to the member 300′ through the supporting element 392, for instance by welding and/or any other suitable means. A damper plate 376 is attached to the flat segment 356 of the shaft 350 using screws 378. The damper plate 376 can pivot inside the casing 334 to engage cushions 374 therein, like in the previous examples. One end of the shaft 350 can be supported in a corresponding hole made across the end plate 390 and another end in a corresponding hole made across the first supporting element 360, as shown. One or both of these holes can include bearings or bushings. Other configurations, arrangements and materials are possible. Among other things, the roll damper mechanism 370 can be constructed completely differently and have other components, such as springs or the like. The shaft 350 can be supported without using any bearing or bushing. Other variants are possible as well.

FIG. 21 further shows an annular bushing 348, for instance made of rubber or the like, positioned on the inner side and surrounding the periphery of the opening through the end plate 390. A similar bushing can be provided around the other opening, this other bushing being also inside the casing 334 in this implementation. These bushings 348 can be engaged by the front and rear edges of the damper plate 376 to absorb shocks. Among other things, the damper plate 376 in this implementation holds the parts together and prevents the shaft 350 from being pulled out of the casing 334 by the longitudinal forces generated during use of the articulated vehicle 104. This simple and cost-effective configuration can be made very robust and is suitable for many applications. Other configurations, arrangements and materials are possible. Among other things, the bushings 348 can be omitted in some implementations and/or the shaft 350 can be attached differently. The casing 334 can remain open during operations, as shown, or be closed by a lid. Other variants are possible as well.

As can be appreciated, the steerable coupling linkage 106 allows the articulated vehicle 104 to be used for a very wide range of applications and purposes that other kinds of vehicles cannot accomplish or cannot achieve with better results. Examples include search and rescue emergency missions, particularly those in response to an incident occurring on a difficult and/or unstable terrain, in a confined space and/or in a hazardous zone. Some missions may even occur under circumstances where all these difficulties are present, for instance in an underground environment such as in a mine or a cave, where a victim must be pulled out of a danger zone by rescuers and then transported towards the surface over some distance through tight passages filled with debris. The articulated vehicle 104 would be particularly well adapted for such mission. Another example is a rescue mission following an avalanche and where the surrounding environment is still very unstable. Minimizing noise and the time spent on the scene will generally be critical factors, and this can be accomplished using an articulated vehicle 104 having for instance an electric motor. Every incident has some unique characteristics and potential dangers for the rescue team. Thus, being able to conduct operations with the maximum efficiency under many different circumstances is always needed in any life-threatening situation. The articulated vehicle 104 can help reach this goal. With the articulated vehicle 104, rescuers can access a remote site very quickly, even in a very difficult environment, bring search and rescue equipment and supplies to find and/or stabilize a victim, pull a victim out of any imminent danger, and move a victim using a stretcher to bring him or her elsewhere, for instance to another evacuation vehicle and/or to other medical response personnel. A same articulated vehicle 104 could even be used to pull two or more victims simultaneously. Search and rescue equipment and supplies that can be carried by the articulated vehicle 104 include medical supplies, mobile life support equipment, rescue equipment such as ropes, harnesses, shovels, floatation equipment, blankets and fire extinguishers, to name just a few, electronic instruments such as sensors, telecommunication systems, global positioning systems (GPS), etc., and any other kinds of supplies that the situation may require, including other items such as tents, food and water, heaters, etc. Other variants are possible as well.

Although the articulated vehicle 104 is extremely useful and well adapted for many difficult search and rescue missions, this is only one among the large number of possible applications and purposes. The articulated vehicle 104 can have many recreational or even military uses, among other things. Regardless of the situation, using the articulated vehicle 104 can be very useful to transport a payload and/or persons, or simply to carry a specific equipment or instrument, on almost any terrain.

The present detailed description and appended figures are only examples. A person working in this field will be able to see that variations can be made while still staying within the framework of the proposed concept. Among other things, and unless otherwise explicitly specified, none of the elements, characteristics or features, or any combination thereof, should be interpreted as being necessarily essential to the invention simply because of their presence in one or more examples described, shown, and/or suggested herein. The word “land” in the term “articulated land vehicle” refers generally to a vehicle capable of applying steering and driving forces on the ground. Such vehicle can nevertheless operate for short periods of times in water, including possibly under water. The steerable coupling linkage could possibly be used on a vehicle that may not be defined as a land vehicle.

### LIST OF REFERENCE NUMERALS

100 primary unit
102 secondary unit
104 articulated vehicle
106 steerable coupling linkage
110 track
112 housing
114 longitudinal axis (of the primary unit)
116 longitudinal axis (of the secondary unit)
120 main body (of the secondary unit)
122 bottom side (of the secondary unit)
124 seat
126 joystick controller
128 hinge (on the secondary unit)
130 front section (of the steerable coupling linkage)
132 rear section (of the steerable coupling linkage)
134 middle section (of the steerable coupling linkage)
136 bottom subpart (of the middle section)
138 top subpart (of the middle section)
140 pitch axis
142 yaw axis
144 roll axis
150 front section frame (of the front section)
160 side plate
162 pivot joint (pitch axis)
164 lever
166 ball
170 bottom subpart frame
172 pivot joint (yaw axis)
180 crossbar
182 endpiece
184 washer
186 seat
188 bolt
190 threaded bore
192 through holes (on a side plate)
194 pitch limiter arrangement
196 stopper
200 steering actuator mechanism
202 actuator
204 actuator rod
206 hydraulic pump unit
208 pressure hoses (schematic)
210 wired connection
212 support
220 swivel member
222 pivot joint
224 vertical pivot axis
230 subframe
232 first vertical axis
234 crossbar
236 pivot joint
238 hinge member
240 second vertical axis
242 arm
244 strut
250 position sensor
252 pin
300 front member
300′ “front” member
302 rear subassembly
304 sleeve
304′ sleeve
306 first through hole
306′ first through hole
308 support
308′ support
310 second through hole
310′ second through hole
320 retention arrangement
320′ retention arrangement
322 threaded rod
322′ threaded rod
324 handle
324′ handle
326 resilient fitting
328 washer
328′ washer
330 threaded hole (on the bottom subpart frame)
332 third through hole
334 casing
336 compartment
340 side bar
342 transversal hole
344 gusset plate
346 back plate
348 bushing
350 shaft
352 nut
354 washer
356 flat segment (of the shaft)
360 first supporting element
362 second supporting element
364 lid
366 screw
370 roll damper mechanism
372 spacer
374 cushion
376 damper plate
378 screw
380 roll locking arrangement
382 pin
382′ pin
383 positioning mechanism
384 hole
385 holder
386 aperture
388 holding block
390 end plate
392 supporting element
410 bumper
420 remote control system

1. A steerable coupling linkage for use between two units arranged in tandem to form an articulated vehicle, the steerable coupling linkage including:
a front section, a rear section and a middle section located between the front and rear sections the middle section being pivotally attached to the front section at a substantially vertical yaw axis; and
a steering actuator mechanism to selectively change a relative angular position of the middle section with reference to the front section about the yaw axis, wherein the steering actuator mechanism includes a steering actuator transversally disposed in the middle section.

2. The steerable coupling linkage as defined in claim 1, wherein the steering actuator comprises a linear actuator having a cylinder and a rod, the cylinder of the steering actuator being rigidly attached to an outer support that is pivotally mounted within the middle section through opposite top and bottom pivot joints around a first substantially vertical axis.

3. The steerable coupling linkage as defined in claim 2, wherein the actuator rod has a free end being pivotally connected to a swivel member at a pivot joint around a second substantially vertical pivot axis, the pivot joint of the swivel member being longitudinally offset in position towards the rear with reference to the yaw axis.

4. The steerable coupling linkage as defined in claim 3, wherein the swivel member is rigidly connected on a rear side of the front section.

5. The steerable coupling linkage as defined in claim 1, wherein the steering actuator comprises a linear actuator having a cylinder and a rod, the cylinder of the steering actuator being supported by a subframe having one end that is pivotally attached within the middle section through opposite top and bottom pivot joints around a first substantially vertical axis, the cylinder of the steering actuator having one end pivotally attached to another end of the subframe at a hinge member around a second substantially vertical pivot axis.

6. The steerable coupling linkage as defined in claim 5, wherein the actuator rod has a free end being pivotally connected to a swivel member at a pivot joint around a third substantially vertical pivot axis, the pivot joint of the swivel member, being longitudinally offset in position towards the rear with reference to the yaw axis, the second and third vertical pivot axes being on opposite sides of the middle section.

7. The steerable coupling linkage as defined in claim 6, wherein the swivel member is rigidly connected on a rear side of the front section.

8. The steerable coupling linkage as defined in claim 1, wherein the front section includes an elongated and transversally extending front section frame pivotally mounted around a substantially horizontal pitch axis.

9. The steerable coupling linkage as defined in claim 8, wherein the front section frame includes a pair of spaced apart and parallel crossbars having ends rigidly connected to opposite endpieces.

10. The steerable coupling linkage as defined in claim 9, further including a pitch limiter arrangement to selectively limit a range of relative angular positions about the pitch axis.

11. The steerable coupling linkage as defined in claim 10, further including opposite side plates by which the front section frame is mounted to the primary unit, the endpiece being pivotally attached to a corresponding one of the side plates.

12. The steerable coupling linkage as defined in claim 11, wherein the pitch limiter arrangement includes a pair of opposite arc-shaped stoppers rigidly attached on one among an interior-facing surface at a top end of a corresponding one the side plates and the front section frame.

13. The steerable coupling linkage as defined in claim 1, wherein the middle section includes a bottom subpart having a U-shaped bottom subpart frame the bottom subpart frame having opposite free ends that are pivotally attached to the front section at corresponding top and bottom pivot joints about the yaw axis.

14. The steerable coupling linkage as defined in claim 13, further including a semi-spherical towing bail extending vertically from a top surface of the bottom subpart frame, the ball having a main central axis that is substantially coincident with the yaw axis.

15. The steerable coupling linkage as defined in claim 13, wherein the middle section further includes a top subpart configured and disposed to cooperate with the bottom subpart frame, the top subpart including a longitudinally extending front member provided to engage the top surface of the bottom subpart frame and having a through hole configured and disposed to receive the ball.

16. The steerable coupling linkage as defined in claim 15, further including a retention arrangement to removably secure the subparts of the middle section.

17. The steerable coupling linkage as defined in claim 1, wherein the rear section is pivotally attached to a rear side of the middle section around a roll axis.

18. The steerable coupling linkage as defined in claim 17, further including a roll damper mechanism.

19. The steerable coupling linkage as defined in claim 17, further including a roll locking arrangement (380) to selectively prevent the rear section from pivoting around the roll axis with reference to the middle section.

20. The steerable coupling linkage as defined in claim 1, wherein the steerable coupling linkage is configured for use between two automotive apparatuses.
